(19) United States
(12) Patent Application Publication
(10) Pub. No.: US 2003/0143039 A1
(43) Pub. Date: Jul. 31, 2003

(54) Router bit system

(76) Inventor: Tyler J. Dembicks, Raleigh, FL (US)

Correspondence Address: Akerman, Senterfitt & Eidson, P.A., Post Office Box 3188, West Palm Beach, FL, 33402-3188, US

(21) Appl. No.: 10/056,840

(22) Filed: Jan. 25, 2002

(51) Int. Cl. B23C 5/16

(52) U.S. Cl. 407/53

(57) ABSTRACT

A router bit system and method. The system includes at least one shaping body having at least one cutting blade and at least one shank, at least one guide bearing and a fastener for detachably coupling the guide bearing to said shaping body in which the shank includes at least one substantially flat surface for receiving a gripping device. The substantially flat surfaces of the shank can include a plurality of raised ridges for providing a slip-resistant gripping surface. In addition, at least a portion of the substantially flat surface of the shank can include a protective material. The cutting blades of the shaping body can remove a predetermined amount of material from a workpiece in which the predetermined amount of the material removed can be partially based upon a radius of the guide bearing.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND

1. Technical Field

The present invention relates generally to woodworking equipment, and more particularly to router bits used to shape or trim sections of wood or other materials.

2. Description of Related Art

Currently, many craftsmen use routers to trim or shape to a desired configuration certain materials such as blocks of wood. For example, a router can be used to sculpt baseboards or crown moldings. A router typically contains an opening for receiving and securing a router bit and includes a motor for rotating the router bit. In addition, a router can receive, secure and rotate a wide variety of router bits, which permits a user to create a large number of designs.

Router bits typically contain a substantially circular guide bearing, which can be used to enable a user to perform a substantially uniform cut as a block of wood is moved along the router bit. In addition, the radius of the guide bearing can help determine the depth at which the cut will be implemented. Thus, a user can replace a particular guide bearing with a large or smaller guide bearing to create a deeper or more shallow cut. To replace a guide bearing, the user usually grasps the shank of the router bit with a grasping device such as a pair of pliers or a wrench, a step that can stabilize the router bit during the replacement procedure.

Unfortunately, this stabilizing step can damage the shank of the router bit thereby reducing its effectiveness. Moreover, a sudden, unexpected movement of the cutting blades of the router bit may occur if the grasping device slips, which can result in serious injury to the user. Thus, what is needed in the art is a router bit that overcomes the limitations of the prior art without significantly increasing costs or design complexity.

### BRIEF DESCRIPTION OF THE DRAWINGS

FIG. 1 is a perspective view of a router bit in accordance with the inventive arrangements.

FIG. 2 is a partial sectional view of the router bit of FIG. 1.

FIG. 3 is a frontal view of a shank of a router bit in accordance with the inventive arrangements.

FIG. 4 is a side view of a shank of a router bit in accordance with the inventive arrangements.

### SUMMARY OF THE INVENTION

The present invention concerns a router bit system. The system includes at least one shaping body having at least one cutting blade and at least one shank, at least one guide bearing and a fastener for detachably coupling the guide bearing to the shaping body in which the shank includes at least one substantially flat surface for receiving a gripping device. In one arrangement, the substantially flat surface of the shank can include a plurality of raised ridges for providing a slip-resistant gripping surface.

At least a portion of the substantially flat surface of the shank can include a protective material. The protective material can be a cushioning material such as rubber or neoprene. In another arrangement, the cutting blades of the shaping body can remove a predetermined amount of material from a workpiece in which the predetermined amount of the material removed can be based in part on a radius of the guide bearing.

In one arrangement, the shank and the shaping body can be uniformly formed such that the shaping body and the shank can be a unitary component. In this particular embodiment, the shank and the shaping body can be formed from a single piece of metal. In another arrangement, the shank and the shaping body can be discrete components such that the shank can be permanently attached to the shaping body. Alternatively, the shank can be detachably coupled to the shaping body in which the router bit system can include a plurality of the shanks. In the arrangement concerning detachably coupled shanks, each shank can include at least one substantially flat surface having a predetermined surface area. In one particular arrangement, none of these predetermined surface areas are equal. Also, in another aspect, if the shanks can be detachably coupled to the shaping body, the router bit system can include a plurality of shaping bodies. The cutting blades on each shaping body can have different configurations.

The invention also concerns a method of replacing a guide bearing of a router bit in which the router bit includes a fastener and a shaping body having at least one substantially flat surface in which the fastener detachably couples the guide bearing to the shaping body. The method includes the steps of: gripping the substantially flat surface of the shank with a gripping device; holding the shank substantially immobile; removing the fastener; replacing the guide bearing with a new guide bearing; and securing the new guide bearing to the shaping body with the fastener.

In one arrangement of the method, the substantially flat surface of the shank can include a plurality of raised ridges for providing a slip-resistant gripping surface. Additionally, at least a portion of the substantially flat surface of the shank can include a protective material. The protective material can be a cushioning material such as rubber or neoprene.

### DETAILED DESCRIPTION OF THE PREFERRED EMBODIMENTS

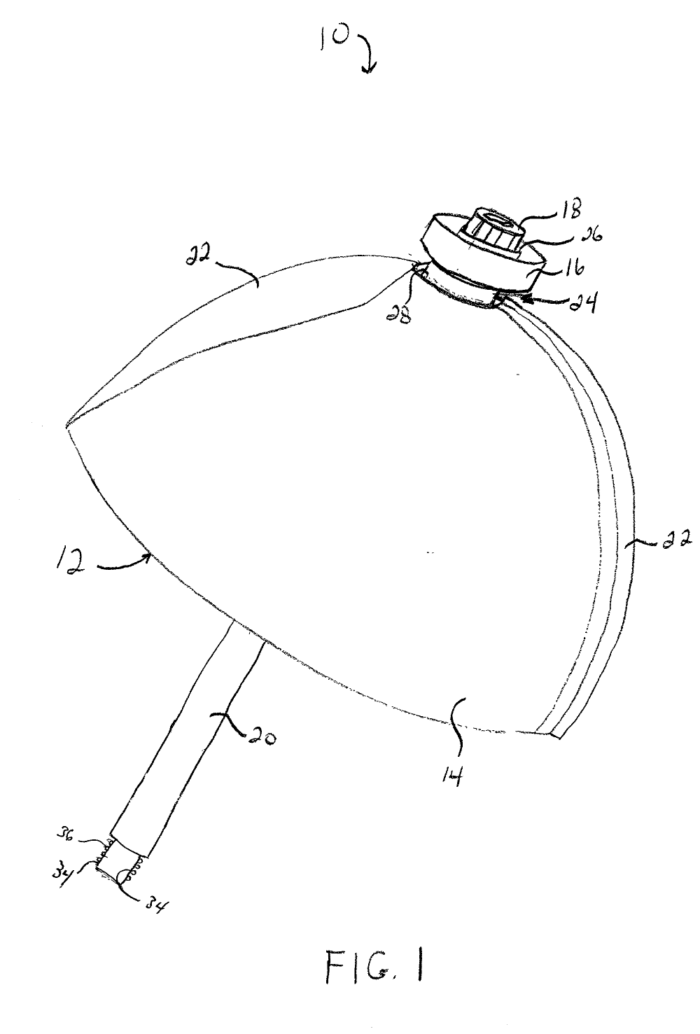

FIG. 1 illustrates a router bit system 10 according to the invention, which can be used to trim or shape certain objects to a desired configuration. As an example, the router bit system 10 can be used to trim blocks of wood or other materials. The system 10 can include a router bit 12, at least one shaping body 14, at least one guide bearing 16 and a fastener 18. The fastener 18 can be any suitable structure such as a screw. In one arrangement, the shaping body 14 can include at least one shank 20 and one or more cutting blades 22. The shaping body 14 and the shank 20 can be uniformly formed such that the shaping body 14 and the shank 20 are considered a unitary component, i.e., no assembly is required. For example, the shaping body 14 and the shank 20 can be formed from a single piece of metal.

Alternatively, the shaping body 14 and the shank 20 can be separate components such that the shank 20 can be either permanently attached or detachably coupled to the shaping body 20. In this embodiment, the shaping body 14 and the shank 20 can be formed from the same material or from different materials. If the shaping body 14 and the shank 20 are detachably coupled, any suitable mechanism can be used for detachably coupling these components. As an example, a spring-biased hitching mechanism can be employed, or the shank 20 can be threadably coupled to the shaping body 14.

The cutting blades 22 can be constructed of any suitable material, including a durable material such as, for example, carbide-tipped steel, to improve the life of the router bit 12. As shown in FIG. 1, the cutting blades 22 can follow the outline of the shaping body 14. It should be noted, however, that the configuration of the cutting blades 22 is not limited to the outline of the shaping body 14, as the cutting blades 22 can be any other suitable shape. In addition, the shaping body 14 is not limited to the particular design illustrated in FIG. 1, as the shaping body 14 can be any other suitable configuration.

In one arrangement, if the shaping body 14 and the shank 20 can be detachably coupled, then the router bit system can include a plurality of shaping bodies 14. The cutting blades 22 for each shaping body 14 can have a different configuration. As such, a wide variety of shaping bodies 14 each having cutting blades 22 of different configurations can be used with the router bit system 10. For purposes of the invention, a configuration of a cutting blade 22 can be the shape of the portion of the cutting blade 22 that can be used to come into contact with and trim the material being shaped. As an example, the configuration for the cutting blades 22 illustrated in FIG. 1 can be the edges of the cutting blades 22 running from an end 24 of the shaping body 14 to the bottom of the shaping body 14. It is understood, however, that the invention is not limited to this particular example, as the cutting blades 22 can have any other suitable configuration.

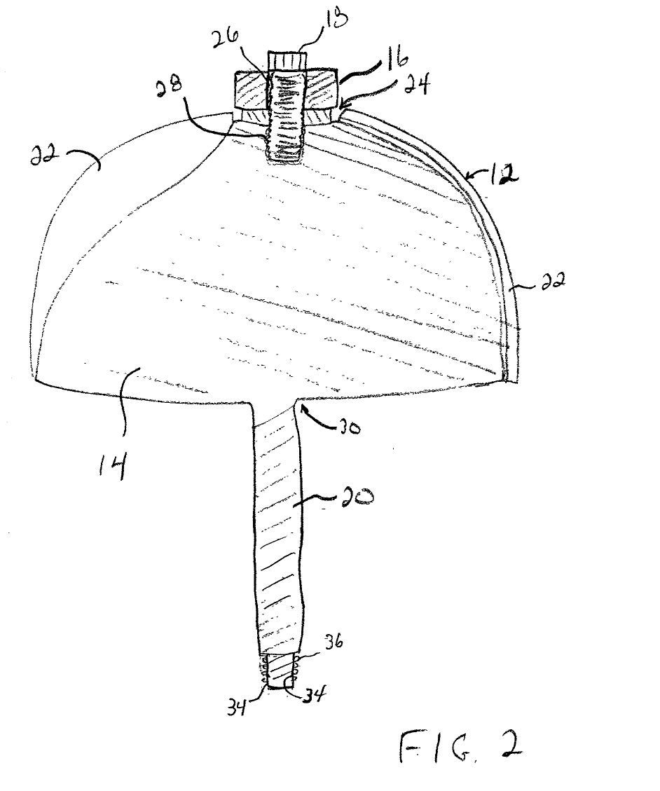

Referring to FIGS. 1 and 2, the guide bearing 16 can be attached to the end 24 of the shaping body 14. In one arrangement, the guide bearing 16 can be substantially circular and can include an aperture 26 for receiving the fastener 18. The end 24 of the shaping body 14 can also include a threaded aperture 28 for receiving the fastener 18 when the aperture 26 of the guide bearing 16 is substantially aligned with the threaded aperture 28. Thus, the fastener 18 can be used to detachably engage the guide bearing 16 to the shaping body 14. It is understood, however, that the guide bearing 16 can be attached to the shaping body 14 by any other suitable structure. Further, the fastener 18 can be designed so as to permit its engagement or removal with a wide variety of tools such as a conventional screw driver or an allen wrench.

In operation, the shank 20 can be inserted into a router (not shown), which can be used to rotate the router bit 12. As the router rotates the router bit 12, the cutting blades 22 on the shaping body 14 can remove a predetermined amount of material from a workpiece, such as a block of wood. The guide bearing 16 can move along a section of the workpiece not being trimmed. In one arrangement, because the workpiece and the guide bearing 16 can be pushed into contact with each other, the radius of the guide bearing 16 can help determine the amount of material removed from the workpiece. Thus, guide bearings 16 of different sizes can change the depth of the cut of the router bit 12. For example, for a deeper cut, a user can replace the current guide bearing 16 with another guide bearing 16 having a smaller radius. Conversely, for a more shallow cut, the user can replace the current guide bearing 16 with a guide bearing 16 having a larger radius. Guide bearings 16 may also wear out over time, which necessitates their replacement.

The shank 20 can include one or more substantially flat surfaces 34 for purposes of receiving a gripping structure of a gripping device (not shown) such as a pair of pliers or a wrench. Each substantially flat surface 34 can have a predetermined surface area. This structure can permit the guide bearing 16 to be removed and replaced with another guide bearing 16 without damaging the shank 20.

For example, the gripping surfaces of the pincers of a pair of pliers can be placed against the substantially flat surfaces 34. After the pair of pliers is engaged, the shank 20 can be held substantially immobile, and the fastener 18 holding the guide bearing 16 in place can be removed. The guide bearing 16 then can be removed and replaced, and the fastener 18 can be tightened. It is understood that the term “substantially” means completely flat as well as slight or even moderate deviations therefrom, at least when discussed in connection with the substantially flat surfaces 34. Although FIGS. 1 and 2 show the substantially flat surfaces 34 as being located at one end of the shank 20, it must be noted that the invention is not limited in this regard. In fact, the substantially flat surfaces 34 can be located at any suitable position on the shank 20.

In another arrangement, if the shank 20 is capable of being detachably coupled to the shaping body 14, then shanks 20 having substantially flat surfaces 34 of varying surface areas can be used in conjunction with the shaping body. As an example, a shank 20 having substantially flat surfaces 34 with a first predetermined surface area can be replaced with a shank 20 having substantially flat surfaces 34 with a second predetermined surface area. The second predetermined surface area can be smaller or larger than the first predetermined surface area. Moreover, shanks 20 having substantially flat surfaces of varying geometric shapes can also be interchangeable with the shaping body 14.

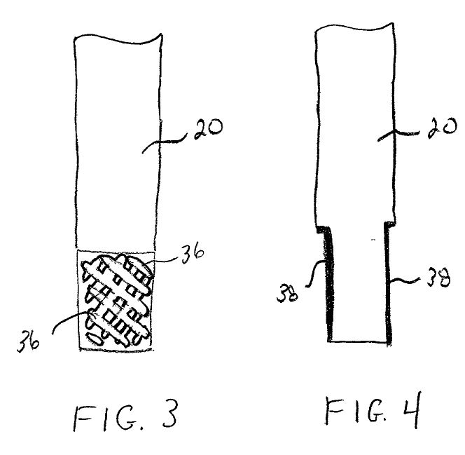

FIG. 3 is a frontal view of a shank 20 in accordance with the inventive arrangements. As illustrated in FIGS. 1, 2 and 3, the substantially flat surfaces 34 can also include a plurality of raised ridges 36 for providing a slip-resistant gripping surface. Although shown in FIG. 3 as employing a criss-cross design, the raised edges 36 can be any other suitable pattern. In another arrangement and as shown in FIG. 4, at least a portion of the substantially flat surfaces 34 of the shank 20 can include a protective material 38 for further protecting the shank 20 from damage caused by the gripping structure of the gripping device. In one arrangement, the protective material 38 can be a cushioning material. Examples of suitable cushioning material 38 can include rubber or neoprene.

While preferred embodiments of the invention have been illustrated and described, it will be clear the invention is not so limited. Numerous modifications, changes, substitutions and equivalents will occur to those skilled in the art without departing from the spirit and scope of the invention as described in the claims.

What is claimed is:

1. A router bit system, comprising:
at least one shaping body having at least one cutting blade and at least one shank;
at least one guide bearing; and
a fastener for detachably coupling said guide bearing to said shaping body;
wherein said shank includes at least one substantially flat surface for receiving a gripping device.

2. The router bit system according to claim 1, wherein said substantially flat surface of said shank includes a plurality of raised ridges for providing a slip-resistant gripping surface.

3. The router bit system according to claim 1, wherein at least a portion of said substantially flat surface of the shank includes a protective material.

4. The router bit system according to claim 3, wherein said protective material is a cushioning material.

5. The router bit system according to claim 4, wherein said cushioning material is rubber.

6. The router bit system according to claim 4, wherein said cushioning material is neoprene.

7. The router bit system according to claim 1, wherein said cutting blades of said shaping body remove a predetermined amount of material from a workpiece;
wherein said predetermined amount of said material removed is based in part on a radius of said guide bearing.

8. The router bit system according to claim 1, wherein said shank and said shaping body are uniformly formed such that said shaping body and said shank are a unitary component.

9. The router bit system according to claim 1, wherein said shank and said shaping body are formed from a single piece of metal.

10. The router bit system according to claim 1, wherein said shank and said shaping body are separate components that are permanently attached to each other.

11. The router bit system according to claim 1, wherein said shank and said shaping body are discrete components such that said shank is detachably coupled to said shaping body;
wherein said router bit system includes a plurality of said shanks.

12. The router bit system according to claim 11, wherein each said shank includes at least one substantially flat surface having a predetermined surface area.

13. The router bit system according to claim 12, wherein none of said predetermined surface areas are equal.

14. The router bit system according to claim 11, wherein said router bit system includes a plurality of shaping bodies.

15. The router bit system according to claim 14, wherein said cutting blades on each said shaping body have different configurations.

16. A method of replacing a guide bearing of a router bit, wherein the router bit includes a fastener and a shaping body having at least one substantially flat surface, wherein the fastener detachably couples the guide bearing to the shaping body, said method comprising the steps of:
gripping the substantially flat surface of the shank with a gripping device;
holding the shank substantially immobile;
removing the fastener;
replacing the guide bearing with a new guide bearing; and
securing the new guide bearing to the shaping body with the fastener.

17. The method according to claim 16, wherein the substantially flat surface of the shank includes a plurality of raised ridges for providing a slip-resistant gripping surface.

18. The method according to claim 16, wherein at least a portion of the substantially flat surface of the shank includes a protective material.

19. The method according to claim 18, wherein the protective material is a cushioning material.

20. The method according to claim 19, wherein the cushioning material is rubber.

21. The method according to claim 19, wherein the cushioning material is neoprene.
